(19) United States
(12) Patent Application Publication
(10) Pub. No.: US 2026/0214124 A1
(43) Pub. Date: Jul. 23, 2026

(54) Global Sovereign Behavior Communication, Navigation, Payment and Service Replacement System Based on 1399 Sovereign Nodes

(71) Applicant: FURONG BEI, SAN GABRIEL, CA (US)

(72) Inventor: FURONG BEI, SAN GABRIEL, CA (US)

(21) Appl. No.: 19/185,254

(22) Filed: Apr. 22, 2025

Related U.S. Application Data
(63) Continuation-in-part of application No. 19/069,268, filed on Mar. 4, 2025.
(63) Continuation-in-part of application No. 19/069,257, filed on Mar. 4, 2025.
(63) Continuation-in-part of application No. 19/070,545, filed on Mar. 5, 2025.
(63) Continuation-in-part of application No. 19/178,867, filed on Apr. 15, 2025.
(63) Continuation-in-part of application No. 19/185,269, filed on Apr. 22, 2025.
(63) Continuation-in-part of application No. 19/072,412, filed on Mar. 6, 2025.
(63) Continuation-in-part of application No. 19/073,040, filed on Mar. 7, 2025.
(63) Continuation-in-part of application No. 19/080,825, filed on Mar. 15, 2025.
(63) Continuation-in-part of application No. 19/096,717, filed on Apr. 1, 2025.
(63) Continuation-in-part of application No. 19/178,874, filed on Apr. 15, 2025.
(63) Continuation-in-part of application No. 19/067,845, filed on Mar. 1, 2025.
(63) Continuation-in-part of application No. 19/067,936, filed on Mar. 2, 2025.
(63) Continuation-in-part of application No. 19/069,285, filed on Mar. 4, 2025.
(63) Continuation-in-part of application No. 19/083,357, filed on Mar. 18, 2025.
(63) Continuation-in-part of application No. 19/091,669, filed on Mar. 26, 2025.
(63) Continuation-in-part of application No. 19/171,375, filed on Apr. 7, 2025.
(63) Continuation-in-part of application No. 19/177,594, filed on Apr. 13, 2025.
(63) Continuation-in-part of application No. 19/072,905, filed on Mar. 6, 2025.
(63) Continuation-in-part of application No. 19/177,252, filed on Apr. 11, 2025.
(63) Continuation-in-part of application No. 19/177,665, filed on Apr. 14, 2025.
(63) Continuation-in-part of application No. 19/179,340, filed on Apr. 15, 2025.
(63) Continuation-in-part of application No. 19/183,053, filed on Apr. 18, 2025.
(63) Continuation-in-part of application No. 19/186,416, filed on Apr. 22, 2025.
(63) Continuation-in-part of application No. 19/083,371, filed on Mar. 18, 2025.
(63) Continuation-in-part of application No. 19/087,483, filed on Mar. 22, 2025.
(63) Continuation-in-part of application No. 19/056,745, filed on Feb. 19, 2025.
(63) Continuation-in-part of application No. 19/058,739, filed on Feb. 20, 2025.
(63) Continuation-in-part of application No. 19/084,753, filed on Mar. 20, 2025.
(63) Continuation-in-part of application No. 19/170,666, filed on Apr. 4, 2025.
(63) Continuation-in-part of application No. 19/177,507, filed on Apr. 12, 2025.
(63) Continuation-in-part of application No. 19/182,542, filed on Apr. 17, 2025.
(63) Continuation-in-part of application No. 19/183,782, filed on Apr. 19, 2025.
(63) Continuation-in-part of application No. 19/083,396, filed on Mar. 18, 2025.
(63) Continuation-in-part of application No. 19/086,150, filed on Mar. 21, 2025.
(63) Continuation-in-part of application No. 19/064,689, filed on Feb. 27, 2025.
(63) Continuation-in-part of application No. 19/069,205, filed on Mar. 3, 2025.
(63) Continuation-in-part of application No. 19/076,910, filed on Mar. 11, 2025.
(63) Continuation-in-part of application No. 19/078,271, filed on Mar. 12, 2025.
(63) Continuation-in-part of application No. 19/177,587, filed on Apr. 13, 2025.
(63) Continuation-in-part of application No. 19/186,257, filed on Apr. 22, 2025.
(63) Continuation-in-part of application No. 19/183,864, filed on Apr. 20, 2025.
(63) Continuation-in-part of application No. 19/069,278, filed on Mar. 4, 2025.
(63) Continuation-in-part of application No. 19/073,058, filed on Mar. 7, 2025.
(63) Continuation-in-part of application No. 19/079,378, filed on Mar. 13, 2025.
(63) Continuation-in-part of application No. 19/174,803, filed on Apr. 9, 2025.
(63) Continuation-in-part of application No. 19/173,863, filed on Apr. 9, 2025.
(63) Continuation-in-part of application No. 19/177,585, filed on Apr. 13, 2025.
(63) Continuation-in-part of application No. 19/060,663, filed on Feb. 22, 2025.
(63) Continuation-in-part of application No. 19/172,519, filed on Apr. 7, 2025.
(63) Continuation-in-part of application No. 19/177,572, filed on Apr. 13, 2025.
(63) Continuation-in-part of application No. 19/185,280, filed on Apr. 22, 2025.
(63) Continuation-in-part of application No. 19/067,932, filed on Mar. 2, 2025, now abandoned.
(63) Continuation-in-part of application No. 19/066,179, filed on Feb. 28, 2025, now abandoned.
(63) Continuation-in-part of application No. 19/083,430, filed on Mar. 19, 2025.
(63) Continuation-in-part of application No. 19/097,892, filed on Apr. 2, 2025.
(63) Continuation-in-part of application No. 19/174,286, filed on Apr. 9, 2025.
(63) Continuation-in-part of application No. 19/051,353, filed on Feb. 12, 2025, now abandoned.
(63) Continuation-in-part of application No. 19/067,888, filed on Mar. 1, 2025, now abandoned.
(63) Continuation-in-part of application No. 19/067,907, filed on Mar. 2, 2025.
(63) Continuation-in-part of application No. 19/069,264, filed on Mar. 4, 2025.
(63) Continuation-in-part of application No. 19/072,953, filed on Mar. 6, 2025.
(63) Continuation-in-part of application No. 19/171,298, filed on Apr. 6, 2025.
(63) Continuation-in-part of application No. 19/172,158, filed on Apr. 7, 2025.
(63) Continuation-in-part of application No. 19/181,772, filed on Apr. 17, 2025.
(63) Continuation-in-part of application No. 19/070,548, filed on Mar. 5, 2025.
(63) Continuation-in-part of application No. 19/073,042, filed on Mar. 7, 2025.
(63) Continuation-in-part of application No. 19/083,345, filed on Mar. 18, 2025.
(63) Continuation-in-part of application No. 19/173,833, filed on Apr. 9, 2025.
(63) Continuation-in-part of application No. 19/078,276, filed on Mar. 13, 2025.
(63) Continuation-in-part of application No. 19/082,758, filed on Mar. 18, 2025.
(63) Continuation-in-part of application No. 19/085,925, filed on Mar. 20, 2025, now abandoned.
(63) Continuation-in-part of application No. 19/084,779, filed on Mar. 20, 2025.
(63) Continuation-in-part of application No. 19/182,490, filed on Apr. 17, 2025.
(63) Continuation-in-part of application No. 19/181,344, filed on Apr. 17, 2025.
(63) Continuation-in-part of application No. 19/183,871, filed on Apr. 20, 2025.
(63) Continuation-in-part of application No. 19/066,022, filed on Feb. 27, 2025, now abandoned.
(63) Continuation-in-part of application No. 19/072,075, filed on Mar. 6, 2025.
(63) Continuation-in-part of application No. 19/084,806, filed on Mar. 20, 2025.
(63) Continuation-in-part of application No. 19/084,805, filed on Mar. 20, 2025, now abandoned.
(63) Continuation-in-part of application No. 19/087,618, filed on Mar. 24, 2025.
(63) Continuation-in-part of application No. 19/094,730, filed on Mar. 28, 2025.
(63) Continuation-in-part of application No. 19/095,713, filed on Mar. 31, 2025.
(63) Continuation-in-part of application No. 19/174,950, filed on Apr. 10, 2025.
(63) Continuation-in-part of application No. 19/051,584, filed on Feb. 12, 2025, now abandoned.
(63) Continuation-in-part of application No. 19/067,732, filed on Feb. 28, 2025.
(63) Continuation-in-part of application No. 19/074,355, filed on Mar. 8, 2025.
(63) Continuation-in-part of application No. 19/074,352, filed on Mar. 8, 2025.
(63) Continuation-in-part of application No. 19/098,985, filed on Apr. 3, 2025.
(63) Continuation-in-part of application No. 19/171,401, filed on Apr. 7, 2025.
(63) Continuation-in-part of application No. 19/183,293, filed on Apr. 18, 2025.
(63) Continuation-in-part of application No. 19/177,509, filed on Apr. 12, 2025.
(63) Continuation-in-part of application No. 19/182,579, filed on Apr. 17, 2025.
(63) Continuation-in-part of application No. 19/183,133, filed on Apr. 18, 2025.
(63) Continuation-in-part of application No. 19/186,359, filed on Apr. 22, 2025.
(63) Continuation-in-part of application No. 19/087,637, filed on Mar. 24, 2025.
(63) Continuation-in-part of application No. 19/176,961, filed on Apr. 11, 2025.
(63) Continuation-in-part of application No. 19/184,222, filed on Apr. 21, 2025.

(51) Int. Cl. H04L 9/40

(52) U.S. Cl. CPC H04L 63/20; H04L 63/0876

(57) ABSTRACT

A computer-implemented sovereign service platform organizes sovereign domain nodes in hierarchical tiers and uses a Behavior-Time Fabric to generate or bind a behavior-linked identity reference and a time-stamp token for an interaction. A Read-Name addressing module resolves a service endpoint using a readable address that includes a BehaviorID, a module identifier, and a domain reference. A Sovereign Data Bus routes requests or responses among modular microservices providing communication, navigation, payment, automated teller, postal, or industry-specific services. Interaction data are protected using a TransfKey-related security function associated with a hardware security module and are anchored on a behavior chain, an identity chain, and an asset chain. Lifecycle policies, geographic and role-based access controls, audit snapshots, and usage reporting support controlled service execution, validation, and review within the sovereign service architecture.

### TECHNICAL FIELD

The present disclosure relates to computer-implemented sovereign service infrastructures and, more particularly, to distributed platform architectures that use sovereign domain nodes, behavior-linked identity, readable service addressing, orchestrated microservices, and parallel chain anchoring for communication, navigation, payment, service execution, and associated audit and security control.

The disclosure is directed to practical network and software operations in which a behavior-linked identity and a time-related interaction reference are used to resolve service endpoints, prepare protected payloads, route requests through a sovereign orchestration layer, and persist interaction records across multiple anchored record layers.

The technical subject matter therefore concerns endpoint discovery, payload formation, routing, security, validation, lifecycle control, and audit generation within a hierarchical sovereign node topology.

### BACKGROUND

Conventional service infrastructures for communication, navigation, payment, automated teller operations, postal interactions, and related digital services are commonly fragmented across different identifiers, different platform providers, and different trust boundaries. A user may be required to maintain multiple unrelated accounts, phone-number-based endpoints, platform-specific credentials, and separate transaction records in order to access routine services.

These fragmented architectures make it difficult to preserve a unified interaction identity, to route requests across heterogeneous service modules, to maintain coherent audit trails, and to enforce common lifecycle controls over interaction data. They also make it difficult to provide consistent protections against tampering, replay, unauthorized access, or inconsistent recordkeeping when a service request traverses multiple technical layers.

A further difficulty arises where different service classes use different identifiers and routing semantics. Communication requests, navigation requests, payment requests, automated teller requests, and industry-specific service requests may each depend on different endpoint formats and different trust models, thereby increasing implementation complexity and limiting interoperability.

Traditional systems also struggle to unify readable addressing with machine-executable routing. Human users benefit from readable service references, but network systems frequently require separate opaque identifiers, static account references, or module-specific addressing conventions. This split increases operational friction and makes consistent policy enforcement more difficult.

Another technical problem concerns security and auditability for service interactions. When a request is formed, encrypted, routed, and recorded across several modules, a practical implementation must ensure that the request can be protected using per-interaction security controls, that downstream service modules receive the correct routing context, and that resulting records can be anchored in a manner suitable for later validation and review.

Still another technical problem concerns controlling the usable life of interaction data after the interaction is complete. Different interactions may require active use, later restriction, expiration, or invalidation under configurable policies. A system that cannot associate lifecycle state with the interaction record itself may fail to enforce reliable post-processing controls.

Accordingly, there exists a need for a sovereign core platform that can organize a plurality of nodes in a hierarchical topology, bind a behavior-linked identity and a time-related interaction reference, resolve readable service addresses, route requests through an orchestration layer, protect payloads using interaction-specific security, and anchor interaction records across multiple coordinated record layers.

There further exists a need for a practical architecture in which representative service modules can share a common address format, a common payload framework, and a common audit model while still supporting different service categories such as communication, navigation, payment, automated teller operations, postal functions, and industry-specific services.

### SUMMARY OF THE DISCLOSURE

Disclosed is a decentralized sovereign core platform in which a plurality of sovereign domain nodes are arranged in hierarchical tiers. A Behavior-Time Fabric module generates and binds a behavior-linked identity reference and a time-stamp token for an interaction. A Read-Name addressing module resolves a service endpoint using a readable syntax that includes a BehaviorID, a module identifier, and a domain-based reference. A Sovereign Data Bus routes requests and responses among modular microservices, and a chain-anchoring layer persists interaction data on behavior, identity, and asset chains while enforcing lifecycle controls.

In various implementations, the platform supports email, voice, messaging, navigation, payment, automated teller, postal, and industry-specific service modules. A unified payload structure can contain a header, encrypted data, and metadata so that different modules can accept a common interaction format while still applying module-specific logic.

The disclosure is directed to practical computer and network operations including endpoint resolution, payload creation, encrypted routing, chain anchoring, audit generation, lifecycle enforcement, and policy-based access control. The technical contribution lies in the coordinated arrangement of these modules within one sovereign service architecture rather than in any isolated commercial objective.

In representative operation, a user device originates a request, the platform generates or validates a BehaviorID, a readable service address is resolved, a payload is created and protected using a TransfKey mechanism associated with a hardware security module, and the resulting interaction is routed through the Sovereign Data Bus to one or more target modules. Interaction data are then anchored across parallel record layers and may later be summarized in audit snapshots or usage reports.

The platform therefore provides a unified technical framework for readable sovereign addressing, behavior-time interaction binding, secure request routing, coordinated multi-chain anchoring, and lifecycle-controlled service execution.

### BRIEF DESCRIPTION OF THE DRAWINGS

FIG. 1 illustrates a hierarchical topology of sovereign nodes including a global root level, intermediate node levels, and local user or organization nodes, together with a Behavior-Time Fabric overlay.

FIG. 2 illustrates a unified addressing and chain-anchoring workflow beginning with a user device and continuing through behavior identity generation, readable address lookup, payload creation, TransfKey protection, Data Bus routing, and parallel chain writing.

FIG. 3 illustrates modular service orchestration in which a gateway and service routing layer are connected with representative communication, navigation, payment, automated teller, postal, and industry service modules.

FIG. 4 illustrates a security and audit architecture in which an application or service layer cooperates with a TransfKey hardware security module and multiple anchored record layers including a behavior chain, an identity chain, an asset chain, and audit logs.

### DEFINITIONS

As used herein, the term “sovereign domain node” refers to a logical node within the disclosed platform topology that participates in addressing, routing, service execution, policy application, record anchoring, or combinations thereof. A sovereign domain node may correspond to a global coordination node, an intermediate node, or a local user or organization node as reflected in the originally filed drawing topology.

As used herein, the term “Behavior-Time Fabric” refers to the interaction-binding layer that associates a behavior-linked identity reference with a time-stamp token or time-related interaction marker for an interaction. The term is used in a current-case-safe manner to denote the layer expressly shown and recited in the filed materials.

As used herein, the term “BehaviorID” refers to a behavior-linked identity reference used to associate an interaction with the platform addressing and routing framework. The term does not require any one particular underlying algorithm beyond the behavior-linked identity function reflected in the originally filed materials.

As used herein, the term “Read-Name addressing” refers to a readable service addressing format in which a BehaviorID, module identifier, and domain-based element are used to resolve a service endpoint. Representative syntax includes BehaviorID@module.domain.24hws.com as expressly reflected in the filed dependent claims and related workflow description.

As used herein, the term “Sovereign Data Bus” refers to the orchestration layer that routes requests, responses, events, or related payloads among modular microservices or associated gateway components.

As used herein, the term “parallel chain anchoring” refers to the writing of interaction-related records to multiple anchored record layers including a behavior chain, an identity chain, and an asset chain, together with optional cross-validation among those layers.

As used herein, the term “lifecycle policy” refers to a control that governs whether interaction data remain active, become restricted, expire, are invalidated, or are otherwise rendered unavailable after a time condition, state condition, or policy condition is satisfied.

As used herein, the term “TransfKey” refers to an interaction-specific or dynamically generated keying mechanism associated with payload protection, as expressly reflected in the originally filed claims and drawings referring to a hardware security module.

### 1. System Topology of Sovereign Nodes

In one embodiment, the platform comprises a mesh network of sovereign domain nodes arranged in hierarchical tiers. The originally filed materials expressly refer to a global root node, intermediate industry-oriented or service-oriented nodes, and local nodes. In the current-case-safe context, the hierarchy is therefore understood as a layered node topology that separates broad coordination functions from more local service execution or user-facing operations.

The node hierarchy may be used to separate global coordination functions from more specialized service domains. An intermediate node may correspond, for example, to an industry grouping, a time-related grouping, an interest grouping, or another routing context consistent with the filed claim language. A local node may correspond to a user device, a user account context, or an organization-level service context.

In the presently disclosed architecture, the node hierarchy is not merely a naming convention. Instead, the hierarchy provides a routing and organizational framework for service discovery, permission scope, service placement, and policy enforcement. A request may originate at or near a local node, inherit a routing context from one or more intermediate nodes, and still remain anchored within the larger sovereign topology.

The hierarchy also supports separation of concerns among system layers. The global root tier may maintain overarching coordination or namespace consistency; one or more intermediate tiers may support module categories, industry segmentation, or other routing partitions; and local nodes may host user-facing or organization-facing interactions. This arrangement allows a common platform architecture to scale across many interactions without requiring every node to perform every system role.

The originally filed drawing language referring to a topology of sovereign nodes is consistent with a mesh interpretation in which adjacent or related nodes may exchange routing information, policy context, or service references. Accordingly, the hierarchy may be combined with local mesh relationships or peer relationships without departing from the filed topology.

In representative use, the node structure can support localization of service execution. A local node can receive a request, an intermediate node can constrain or interpret the request according to domain or service context, and the root layer can preserve namespace coherence or broader routing integrity. This layered participation helps provide deterministic endpoint resolution and auditable request progression.

Because the claims also contemplate secondary subdomain endpoints, the node hierarchy may support subordinate service endpoints beneath a sovereign node. These secondary endpoints may correspond to specialized services, service variations, or narrower endpoint roles while still inheriting the larger node context.

The hierarchical topology therefore provides technical support for readable addressing, service partitioning, route selection, and later policy or audit interpretation across a distributed sovereign service infrastructure.

### 2. Behavior-Time Fabric

The Behavior-Time Fabric operates as the interaction-binding layer of the platform. For each interaction, the module generates or binds a behavior-linked identity reference and an associated time-stamp token or time-related interaction reference. This function is expressly reflected in the filed claims and is central to the current-case-safe reading of the disclosure.

In representative operation, the Behavior-Time Fabric receives information from a user device or an upstream module regarding a service request or other interaction. The module then associates the interaction with a BehaviorID and a time-stamp token so that the interaction carries both an identity-linked and time-linked reference before routing or anchoring occurs.

The filed dependent claims further disclose that the Behavior-Time Fabric may inject entropy from user behavior and time parameters. In a current-case-safe reading, this means that behavior-related and time-related information may contribute to differentiation of interactions, uniqueness of request contexts, or protection against duplication or ambiguity among otherwise similar requests.

The Behavior-Time Fabric may also act as a state-binding layer between request creation and downstream routing. Once an interaction is associated with a behavior-linked identity reference and a time-related marker, later modules can process the interaction without needing to recreate that identity-time association independently.

In some implementations consistent with the filed workflow, the time-stamp token may be attached before or during payload formation. In other implementations, the Behavior-Time Fabric may provide the inputs needed for later attachment or validation. The present specification therefore treats the module as a practical coordinator of behavior-linked and time-linked request context.

A useful technical effect of the Behavior-Time Fabric is that different service modules can receive a common interaction context. Whether the target service relates to communication, navigation, payment, or another category, the request may still be expressed in terms of the same behavior-linked identity and time-linked interaction reference.

The Behavior-Time Fabric also supports later lifecycle and audit functions. Because the interaction carries an identity-linked and time-linked marker from an early stage, later modules can apply expiration, restriction, reporting, or validation logic using a common interaction reference rather than unrelated local identifiers.

Accordingly, the Behavior-Time Fabric is not merely descriptive. It is the practical interaction-binding mechanism that allows the rest of the disclosed platform to operate on coherent request objects.

### 3. Read-Name Sovereign Addressing

The filed disclosure expressly identifies a Read-Name sovereign addressing module employing a BehaviorID@module. domain.24hws.com syntax for unified endpoint resolution. This readable address format is one of the most distinctive features of the current application and is treated here in a manner consistent with the originally filed dependent claims and workflow description.

In operation, a service request may be received with such an address, or an address may be constructed after generation of the BehaviorID. The addressing module resolves the target endpoint based on the BehaviorID, the named module, and the relevant domain or sovereign node context.

The originally filed dependent claims further disclose DNS-like lookup and endpoint resolution subject to geographic and role-based policies. In the present specification, those functions are described as practical mechanisms for translating a readable address into a service endpoint while still respecting routing or access constraints.

The use of a readable address provides a technical advantage in multi-service environments. The same address structure can be used across service categories while still differentiating the requested module. This reduces dependence on unrelated endpoint schemes and allows a common resolution layer to operate for multiple service classes.

A readable address may identify a local service endpoint, a node-scoped service endpoint, or an endpoint associated with a broader intermediate tier. The resolution logic can therefore determine not only which service is requested, but also where within the sovereign node topology the corresponding service should be obtained.

The Read-Name module may operate before payload routing and may also cooperate with policy enforcement. For example, the resolution result may be filtered or constrained by geographic rules, role-based permissions, or node-specific access controls before the request is delivered to a target module.

The filed materials also support dynamic generation of secondary subdomain endpoints for specialized services. In a current-case-safe reading, this means that a sovereign node may host subordinate endpoints corresponding to specialized modules or service roles while preserving the same overall readable addressing framework.

Read-Name addressing therefore serves as both a usability mechanism and a network control mechanism. It gives a common, interpretable address syntax while also enabling deterministic endpoint resolution in a distributed sovereign architecture.

### 4. Payload Structure and Request Formation

The originally filed workflow identifies payload creation as including header, encrypted_data, and metadata. The filed dependent claims also specify a unified header and payload schema with fields such as module identifier, behavior identifier, timestamp, request identifier, signature, encrypted data, and metadata including a need category or industry code. These disclosures are treated here in a current-case-safe manner as representative payload fields.

A service request can thus be assembled into a structured payload. The header portion may identify the module, the behavior-linked reference, the request context, and a timestamp value. The encrypted portion may carry interaction content or protected service data. The metadata portion may carry classification information used for routing, policy, audit, billing, or reporting.

The use of a unified schema permits common treatment of interactions across otherwise different service modules. Communication, navigation, payment, and industry-specific modules can therefore receive inputs that are normalized at the platform level even if the service logic later diverges.

The request identifier field may be used to correlate platform events, downstream module operations, later audit snapshots, or subsequent reports. The signature field may support request integrity and source attribution. The metadata field may support routing, grouping, usage aggregation, or policy selection consistent with the originally filed dependent claims.

Payload formation can occur after generation or validation of the BehaviorID and after or during association of the time-stamp token. The resulting request object is therefore a structured interaction carrier suitable for later encryption, routing, anchoring, and audit functions.

In representative operation, the platform can treat payload formation as a normalization stage. Inputs arriving from different front-end devices or module contexts can be converted into a common internal request object before routing through the Data Bus. This improves consistency across otherwise different service interactions.

The payload framework also supports later tokenized records or asset records where such records are aligned with the service interaction. In that context, the payload can provide the interaction context needed for the asset record without requiring a different interaction format for every service domain.

Accordingly, the payload structure is a practical, technical component of the disclosed platform and not simply a notation. It provides the common interaction representation upon which routing, security, anchoring, and reporting operate.

### 5. TransfKey Generation and Encryption

The drawings and dependent claims expressly refer to TransfKey generation and a hardware security module. In representative embodiments, the payload or portions of the interaction data are protected by a dynamic one-time TransfKey generated in or with the aid of a hardware security module for the interaction.

The present description therefore treats the TransfKey mechanism as a per-interaction or dynamically generated keying function used to secure payload data or associated records. The key may be generated as part of the process of encrypting the payload prior to Data Bus submission or chain anchoring.

This arrangement provides a practical security function within the disclosed platform. It strengthens confidentiality and integrity at the interaction level while remaining consistent with the filed disclosure linking payload creation, encryption, and later routing.

The use of a hardware security module further indicates that the platform can externalize or protect key material away from ordinary application memory. The current-case-safe disclosure therefore recognizes the HSM as a secure generation or support component for the TransfKey function, without relying on any unfiled cryptographic implementation detail.

A per-interaction keying mechanism also assists in controlling the scope of downstream exposure. If a request or record is associated with an interaction-specific key context, later restriction, invalidation, or unavailability may be managed in coordination with lifecycle controls and downstream access policy.

In representative sequences, payload encryption need not be the final stage of protection. The encrypted payload may still be accompanied by signatures, request identifiers, timestamps, or metadata fields so that routing and validation can proceed without exposing protected interaction content.

The TransfKey mechanism can also cooperate with chain anchoring and audit. For example, an anchored record may reference an interaction that was protected using a TransfKey-generated encryption context, thereby allowing later validation of process integrity even when service content remains protected.

The filed materials thus support a practical reading of TransfKey generation as an interaction-specific security mechanism integrated into payload formation, routing, and downstream record handling.

### 6. Sovereign Data Bus Orchestration

The Sovereign Data Bus is the orchestration layer that routes API requests and responses among modular microservices. The originally filed claims and workflow expressly identify submission to the Sovereign Data Bus as a stage following payload formation, encryption, and time-stamp attachment.

In representative operation, the Data Bus receives the request, interprets the target module and routing context, and forwards the interaction to a targeted microservice. The Data Bus may also support real-time event streaming and on-demand microservice discovery, as recited in the originally filed dependent claims. These functions enable modular expansion without requiring each service to implement an entirely separate transport or routing framework.

The orchestration layer may further cooperate with gateway controls such as load balancing, rate limiting, or token-bucket enforcement, which are also expressly disclosed in the originally filed dependent claims. These gateway functions help preserve system availability and control routing behavior under variable request conditions.

Because the Data Bus operates after readable endpoint resolution and after request normalization, it can serve as the common execution path for many service categories. This avoids the need for isolated routing systems for mail, voice, navigation, payment, automated teller, postal, and industry-specific requests.

In some implementations, the Data Bus can route a request to one module, to multiple modules in sequence, or to additional support services such as validation, logging, or audit generation. The present specification treats those operations as representative orchestration functions that remain within the originally filed service routing concept.

The Data Bus may also preserve correlation between upstream addressing and downstream service execution. For example, the request identifier, module identifier, BehaviorID, or metadata fields may remain associated with the request as it traverses one or more modules. This supports consistent downstream anchoring and later reporting.

A further practical benefit is that the Data Bus can act as a single control point for policy-aware routing. Even where service modules differ in function, a common orchestration layer can apply queueing, admission, routing, or policy gates before the interaction is delivered.

Accordingly, the Sovereign Data Bus is a central technical element of the platform and should be understood as the routing and orchestration core that allows the distributed sovereign architecture to function cohesively.

### 7. Modular Microservices and Service Domains

The original claim set expressly identifies modular microservices for email, voice, messaging, navigation, payment, ATM, postal, and industry-specific extensions. The drawings also depict representative modules including Mail, Voice, Nav, Pay, Msg, Health, Edu, Tour, Bank, and Shop. The present specification therefore treats those service types as representative disclosed microservice categories.

A communication module may process messages or voice-related interactions. A navigation module may process route or destination-oriented requests. A payment or automated-teller module may process transaction or access operations. A postal module may process routing or delivery-related service objects. Industry modules may provide specialized processing for fields such as healthcare, education, tourism, banking, and electronic commerce.

The filed dependent claims also recite that industry-specific microservices can issue tokenized assets aligned with regulatory compliance. In the current-case-safe context, this means that a service interaction may be associated with a tokenized record or asset record generated in a manner consistent with the platform chain anchoring, metadata, and policy controls.

The modular structure supports reuse of the same platform foundation across different service domains. A readable address may identify different modules, but the surrounding architecture can still rely on the same identity-time binding, payload schema, Data Bus routing, chain anchoring, and lifecycle control framework.

The service categories depicted in the drawings are representative rather than limiting. They show that the platform can host multiple service classes under one architecture, not that every implementation must include every depicted module at all times.

In some operational contexts, a request may traverse more than one module. For example, a communication interaction may trigger a payment-related record, or a navigation interaction may generate an asset-related or report-related record. The current-case-safe disclosure recognizes that modules may cooperate through the Data Bus and shared interaction context.

The module framework also allows service deployment to vary by node or node tier. Certain modules may be active at one node but not another, while still remaining within the same sovereign addressing and routing framework.

The disclosed microservice architecture therefore provides a practical basis for platform extensibility while remaining technically anchored to the originally filed service categories and routing structures.

### 8. Zero-Trust Isolation and Network Policies

The originally filed dependent claims disclose that each microservice may be isolated within a zero-trust containerized environment enforcing per-module network policies. This disclosure is treated here as a practical architecture in which each service module may be confined to a controlled execution boundary and communicate through approved interfaces.

In representative operation, each microservice may execute within its own controlled environment, may communicate through the Data Bus or an associated gateway, and may be subject to module-specific network rules, service admission rules, or endpoint restrictions.

Zero-trust isolation is particularly useful where the platform supports many different service categories under one common architecture. By keeping services logically bounded while still allowing orchestrated routing, the system reduces unnecessary coupling among service modules and improves containment of faults or unauthorized access attempts.

Per-module policies may define which request classes are accepted, which upstream or downstream modules are reachable, and which portions of the payload or metadata are made available to the target service. Such controls can be applied without changing the readable addressing syntax or the higher-level request model.

The current-case-safe disclosure does not require any one container technology. Rather, the zero-trust concept is used in a class-based manner to describe bounded service execution environments and policy-governed inter-service communication as reflected in the originally filed claims.

This architecture also complements lifecycle controls and audit functions. If a module executes in an isolated environment with defined network policies, later access restriction or audit review can be associated with a bounded service context rather than a diffuse platform state.

The disclosed isolation approach therefore contributes to platform integrity, policy enforcement, and predictable service composition across multiple representative service domains.

### 9. Parallel Chain Anchoring

The chain-anchoring layer is one of the most important features expressly disclosed in the filed claims and drawings. The platform anchors interaction data on parallel behavior, identity, and asset chains rather than relying on a single record stream for all interaction semantics.

In a representative implementation, behavior logs are written to the Behavior Chain, identity proofs or identity-linked records are written to the Identity Chain, and asset records or tokenized interaction records are written to the Asset Chain. The same interaction may therefore have corresponding records across more than one anchored layer.

The original claim set also discloses multi-chain validation that cross-verifies transaction data across the chains to detect tampering. The present specification therefore treats parallel anchoring not simply as duplication, but as a structured recordkeeping model in which different categories of interaction information are anchored in coordinated but distinguishable record layers.

This architecture can improve integrity analysis because a later review may compare whether the behavior-linked record, the identity-linked record, and the asset-linked record remain mutually consistent. If inconsistency arises, the platform can detect a deviation that would not necessarily be visible in an undifferentiated single-record model.

Parallel chain anchoring also allows different modules to rely on different record types while still referencing the same underlying interaction. A service module may use a behavior-linked reference, an identity-related function may rely on the identity chain, and a settlement-related or tokenized output may rely on the asset chain.

In representative operation, the chain-writing step follows Data Bus routing and service handling. The anchored records therefore reflect the service interaction after request resolution, protection, and module processing have occurred.

The drawings also depict audit logs in association with the security and anchoring layers. The current-case-safe disclosure therefore recognizes that parallel anchoring may be accompanied by separate audit records, snapshots, or reports without altering the core three-chain model.

The disclosed parallel chain arrangement provides a practical, layered integrity framework within the sovereign service platform.

### 10. Lifecycle Policies and Self-Destruct Controls

The originally filed claims state that interactions may be subject to self-destruct policies, and the dependent claims specify that such policies may be enforced via chain-anchored lifecycle tags integrated with the time-stamp token. In a current-case-safe reading, the term self-destruct is understood as a lifecycle-driven control over availability or accessibility of at least part of the interaction data.

A lifecycle policy can define whether particular interaction data remain active, become restricted, expire, or are rendered unavailable after a specified event, threshold, or time condition. Because the originally filed disclosure links lifecycle enforcement with a time-stamp token, the time-related reference can serve as one input to the later state transition.

This mechanism allows the platform to apply a temporal or policy-driven state change to interaction data while preserving an auditably anchored record of the interaction itself. Thus, the platform can support controlled reduction of data availability without requiring erasure of all related system evidence.

In representative operation, a lifecycle tag may be created during or after request processing, may be anchored with other interaction records, and may later be consulted when an access request, validation step, or reporting operation is attempted. If the associated condition has been met, the relevant data may be restricted, invalidated, or no longer exposed through ordinary access paths.

The current-case-safe disclosure does not require physical deletion in every implementation. Rather, the filed materials support a broader lifecycle concept in which expiration, unavailability, restriction, or invalidation may be applied in a manner consistent with the interaction record and the associated time condition.

Lifecycle policies may also cooperate with security and audit layers. For example, a record may become unavailable to a service module while a summary or anchored audit reference remains present for later review. This coordination helps reconcile operational control with later verification needs.

The lifecycle framework therefore provides a practical state-control mechanism for interaction data and is an important technical feature of the disclosed sovereign platform.

### 11. Access Policies

The originally filed dependent claims expressly disclose geographic and role-based access policies. In the present description, those policies are treated as filters or controls that may be applied during endpoint resolution, request admission, Data Bus routing, service execution, or later record access.

A geographic policy may restrict a service interaction to particular node groupings, areas, or routing paths. A role-based policy may determine whether a user, organization, or service process has access to a requested module, requested data, or requested function.

Because the platform already uses a structured behavior-linked identity and a node hierarchy, geographic and role-based policies can be enforced without requiring every service module to implement a separate identity framework. A common addressing and orchestration layer can instead supply a policy context for module handling.

Policies may also be used to influence endpoint selection. Where more than one candidate endpoint exists for a readable address or service class, the applicable geographic or role rule may select, prioritize, or reject one or more endpoint candidates.

The same policy framework can also influence downstream visibility of payload fields or anchored records. For example, a module may receive only a bounded subset of request information while a more privileged function receives additional context, all without changing the overall request identity.

In representative operation, role and geographic controls therefore help provide deterministic service behavior in a distributed sovereign architecture while remaining fully consistent with the originally filed dependent claim language.

### 12. Audit Ledgers and Usage Reporting

The original claim set further discloses configurable audit snapshots stored on a separate audit ledger resistant to deletion, and usage reports aggregating user interactions by demand category, industry code, or sovereign node for billing or compliance monitoring.

In representative embodiments, the platform may periodically produce audit snapshots that summarize or capture aspects of interaction activity. These snapshots can be stored separately from the principal service interaction chains so as to preserve a reporting or oversight layer that is resistant to ordinary deletion or modification.

The platform may also aggregate usage information across service categories or sovereign nodes. Such reporting may be used for billing, operational management, compliance review, or system analysis, as expressly indicated by the filed dependent claims.

Because the payload structure may include metadata such as a need category or industry code, and because requests are routed through identifiable sovereign nodes, the platform can generate reports according to those categories without requiring each module to maintain its own isolated reporting standard.

Audit snapshots and usage reports can also cooperate with later validation. A snapshot may preserve a platform state or summary at a particular interval, while a usage report may aggregate interactions over a reporting period. These outputs may therefore serve different but complementary oversight functions.

The present specification treats these reporting features as practical system functions that improve observability and manageability of the sovereign core platform while remaining tied to the filed disclosure.

### 13. Representative Operating Sequence

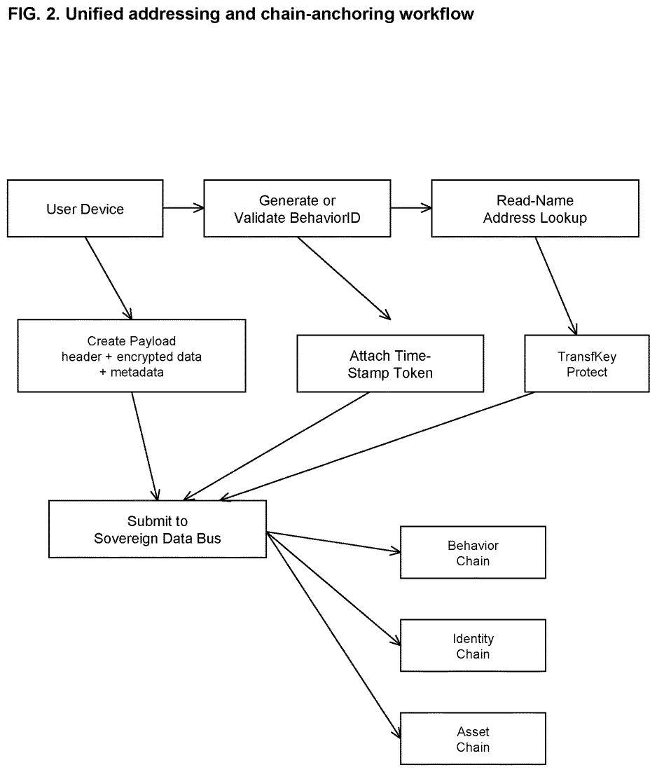

A representative operating sequence consistent with FIG. 2 begins with a user device originating a service request. The platform generates or validates a BehaviorID, looks up a readable address, creates a payload including header, encrypted data, and metadata, protects the payload using a TransfKey-related security function, submits the interaction to the Sovereign Data Bus, and writes interaction records to the behavior, identity, and asset chains.

The same sequence may be applied across more than one service category. For example, a navigation request and a payment request may each rely on the same addressing, payload, encryption, and chain-anchoring framework while ultimately reaching different microservices.

This reuse of a common interaction sequence across different service modules is one of the practical strengths of the disclosed platform. It allows a single sovereign core architecture to organize multiple service classes without discarding the technical commonality needed for routing, security, lifecycle, and audit control.

In some implementations, gateway controls such as load balancing or rate limiting may be applied during the sequence. In other implementations, lifecycle tagging or audit snapshot generation may occur after service processing or after chain anchoring. The filed materials support these variations so long as the core interaction framework remains the same.

The operating sequence can also preserve a coherent relationship between request origin, endpoint selection, service handling, and later records. This continuity is important for later validation, cross-chain review, and lifecycle enforcement.

Accordingly, FIG. 2 and the related filed claim language are consistent with a repeatable, generalized service-processing sequence that can be implemented across multiple sovereign service domains.

### 14. Representative Service Scenarios

Without departing from the originally filed disclosure, representative service scenarios include communication-oriented interactions using mail, voice, or messaging modules; route-oriented or location-oriented interactions using navigation modules; transaction or access interactions using payment or automated teller modules; delivery or routing interactions using postal modules; and specialized interactions using healthcare, education, tourism, banking, or electronic commerce modules.

In each scenario, the interaction can still be expressed through the same core architecture: a behavior-linked identity and time reference, a readable address, a structured payload, secure routing through the Data Bus, and anchored records across multiple chains. This commonality is one reason the disclosed architecture can serve as a sovereign core platform rather than as a single-purpose application.

A communication scenario may involve a message request that is addressed using the readable syntax, protected using the interaction security function, delivered to a communication module, and later reflected in anchored records. A navigation scenario may involve a route-oriented request that follows the same overall sequence while targeting a navigation module. A payment scenario may involve a value or access request that similarly uses the same address-resolution, payload, routing, and anchoring framework.

Industry-specific scenarios may include healthcare-related processing, education-related processing, tourism-related processing, banking-related processing, or electronic-commerce-related processing. The present specification does not attempt to add new sector-specific algorithms, but instead explains how the already filed sovereign core architecture can support those representative service domains.

The filed dependent claims also support tokenized records aligned with service interactions. Accordingly, a representative scenario may further produce an asset record or tokenized interaction record without changing the sovereign node structure, identity binding, Data Bus routing, or chain-anchoring foundations of the platform.

These service scenarios are therefore representative embodiments that illustrate repeated application of the same current-case-safe technical core rather than unrelated expansions beyond the originally filed disclosure.

### 15. Technical Advantages Within the Filed Disclosure

Within the scope of the originally filed disclosure, the platform provides several practical technical advantages. First, it provides a unified and readable endpoint resolution mechanism using a BehaviorID@module.domain.24hws.com syntax. Second, it provides a common request structure that can be reused across different service modules.

Third, it provides interaction-specific protection using a TransfKey function associated with a hardware security module. Fourth, it provides layered integrity and audit capability through parallel anchoring on behavior, identity, and asset chains, together with optional audit ledgers and cross-validation. Fifth, it provides lifecycle-driven control over interaction data after the interaction is complete.

Sixth, it allows geographic and role-based policies to be applied within a common sovereign architecture rather than forcing each service domain to define a separate trust framework. Seventh, it supports modular expansion through a Data Bus and microservice arrangement while preserving a common addressing and recordkeeping model.

These advantages arise from the coordinated arrangement of the disclosed modules and not from any newly introduced matter. The current-case-safe specification is intended to make those advantages clearer to the reader while remaining within the technical scope already reflected in the filed materials.

### 16. Consistency With Originally Filed Materials

The present substitute specification is intentionally drafted to remain closely aligned with the originally filed claims, abstract, and drawings associated with U.S. application Ser. No. 19/185,254. References to sovereign nodes, the Behavior-Time Fabric, Read-Name sovereign addressing, a Sovereign Data Bus, modular microservices, TransfKey generation, chain anchoring, lifecycle tags, zero-trust environments, and audit-related functions are all drawn from the originally filed materials.

Where the present description uses fuller prose than the originally filed text, it is intended to clarify the structure and operation already reflected in the filed disclosure and not to introduce a different invention. Sector examples, routing examples, and operational sequences are provided only as representative explanations of filed subject matter.

Similarly, the accompanying drawings are described and used in a manner consistent with their original appearance in the filed materials and are intended to provide clearer structural explanation rather than to change the invention.

### 17. Figure-by-Figure Explanation

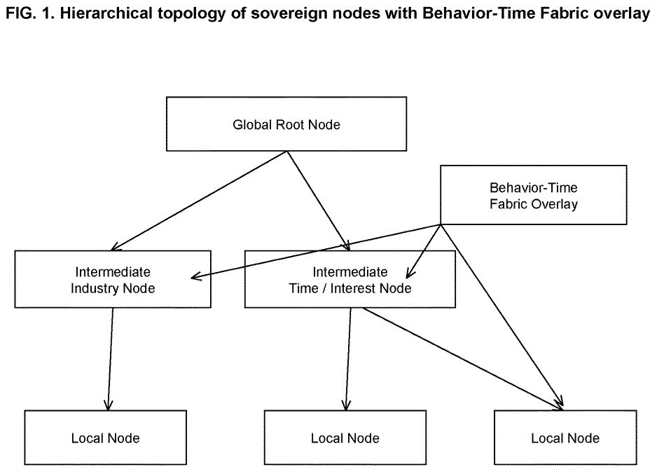

FIG. 1 may be understood as showing a root-to-intermediate-to-local node arrangement together with an overlaid Behavior-Time Fabric. The figure communicates that the identity-time binding layer is used across more than one node tier rather than being confined to a single endpoint.

FIG. 2 may be understood as showing an operational sequence in which BehaviorID generation, Read-Name lookup, payload creation, TransfKey protection, Data Bus submission, and chain writing are logically related stages of a single interaction workflow.

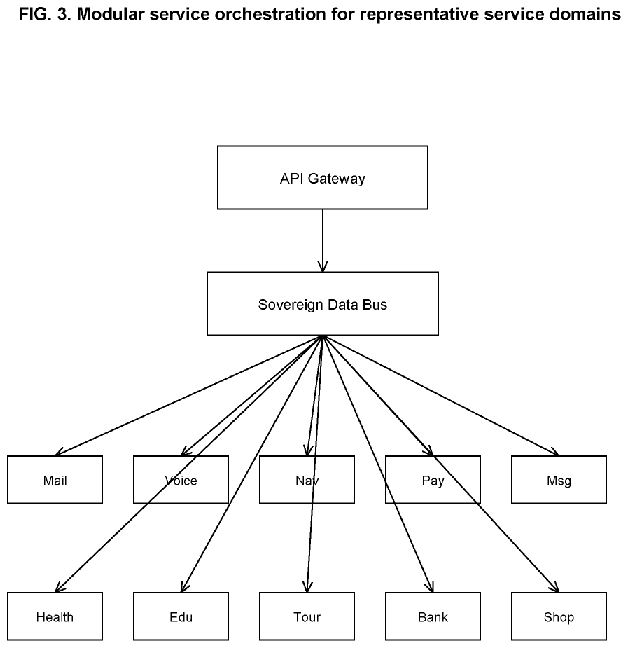

FIG. 3 may be understood as showing that a common routing and gateway layer can feed a plurality of distinct modules including communication, navigation, payment, and industry service modules. The figure supports the modular yet unified nature of the disclosed platform.

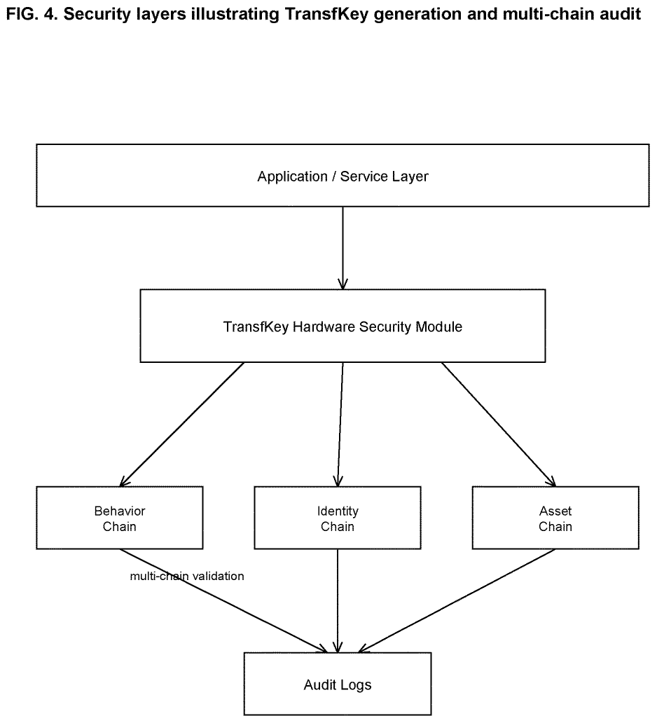

FIG. 4 may be understood as showing that the application or service layer cooperates with a TransfKey hardware security module and with multiple anchored record layers. The figure thereby supports the layered relationship among request handling, security, and auditable record generation.

### 18. Scope and Current-Case-Safe Characterization

The present disclosure is intended to explain, in fuller current-case-safe form, the sovereign service architecture originally filed in connection with U.S. application Ser. No. 19/185,254. The disclosure is therefore focused on clarifying the technical interaction of the already filed modules and record layers.

Nothing in this substitute specification is intended to require any one unfiled algorithm, commercial deployment model, or sector-specific implementation detail. Instead, the present text emphasizes the common architecture reflected in the filed materials: hierarchical sovereign nodes, behavior-time binding, readable addressing, Data Bus orchestration, interaction-specific security, parallel chain anchoring, lifecycle control, and audit functions.

Persons of ordinary skill in the relevant computer and network arts will understand that variations may be implemented within those disclosed technical themes while remaining consistent with the originally filed subject matter and the accompanying claims.

1. A computer-implemented sovereign service platform system comprising: a plurality of sovereign domain nodes arranged in hierarchical tiers including a global root tier, one or more intermediate tiers, and one or more local user or organization nodes; a Behavior-Time Fabric module configured to generate or bind a behavior-linked identity reference and a time-stamp token for an interaction; a Read-Name addressing module configured to resolve a service endpoint using a readable address that includes a BehaviorID, a module identifier, and a domain reference; a Sovereign Data Bus orchestration layer configured to route requests or responses among modular microservices; a plurality of modular microservices configured to provide one or more of communication, navigation, payment, automated teller, postal, or industry-specific services; and a chain-anchoring layer configured to anchor interaction data on a behavior chain, an identity chain, and an asset chain and to enforce a lifecycle policy for the interaction data.

2. The system of claim 1, wherein the plurality of sovereign domain nodes includes at least 1399 sovereign nodes.

3. The system of claim 1, wherein the sovereign domain nodes are dynamically configurable to generate secondary subdomain endpoints for specialized services.

4. The system of claim 1, wherein the Read-Name addressing module resolves a service endpoint using a BehaviorID@module.domain.24hws.com syntax.

5. The system of claim 1, wherein a unified header and payload schema comprises a module identifier, a behavior identifier, a timestamp, a request identifier, a signature, encrypted data, and metadata including a need category or an industry code.

6. The system of claim 1, wherein the Sovereign Data Bus supports real-time event streaming or on-demand microservice discovery.

7. The system of claim 1, wherein each microservice is isolated within a zero-trust containerized environment enforcing a per-module network policy.

8. The system of claim 1, wherein the industry-specific services include one or more of healthcare, education, tourism, banking, or electronic commerce services.

9. The system of claim 1, wherein at least one of the modular microservices is configured to generate a tokenized asset or tokenized interaction record aligned with a service interaction.

10. The system of claim 1, wherein a dynamic one-time TransfKey is generated in a hardware security module for an interaction, and wherein the chain-anchoring layer performs multi-chain validation across the behavior chain, the identity chain, and the asset chain.

11. A computer-implemented method of providing sovereign replacement services, the method comprising: receiving a service request using a readable address that includes a BehaviorID, a module identifier, and a domain reference; generating or validating a behavior-linked identity reference and a time-stamp token for the service request; creating a payload including header information, encrypted data, and metadata; protecting at least part of the payload using a TransfKey-related security function; routing the service request through a Sovereign Data Bus to a target modular microservice; and writing interaction-related data to a behavior chain, an identity chain, and an asset chain while applying a lifecycle policy to the interaction data.

12. The method of claim 11, further comprising resolving a target service endpoint using DNS-like lookup of a BehaviorID@module.domain.24hws.com address while enforcing geographic or role-based access policies.

13. The method of claim 11, wherein the metadata maps at least one demand category or one industry code to the service request.

14. The method of claim 11, further comprising load balancing, rate-limiting, or token-bucket enforcement through an API gateway module.

15. The method of claim 11, further comprising generating and storing audit snapshots at configurable intervals on a separate audit ledger resistant to deletion.

16. The method of claim 11, further comprising generating a usage report aggregating user interactions by demand category, industry code, or sovereign node for billing or compliance monitoring.

17. The method of claim 11, wherein writing interaction data to the behavior chain, the identity chain, and the asset chain comprises writing behavior logs to the behavior chain, identity proofs to the identity chain, and asset or tokenized interaction records to the asset chain.

18. The method of claim 11, further comprising generating a tokenized asset corresponding to the interaction.

19. The method of claim 11, wherein applying the lifecycle policy comprises expiring, invalidating, restricting, or rendering unavailable at least part of the interaction data after a time condition or lifecycle condition is satisfied.

20. A non-transitory computer-readable medium storing instructions which, when executed by one or more processors, cause the one or more processors to: receive a service request using a readable address that includes a BehaviorID, a module identifier, and a domain reference; generate or validate a behavior-linked identity reference and a time-stamp token for the service request; create a payload including header information, encrypted data, and metadata; protect at least part of the payload using a TransfKey-related security function; route the service request through a Sovereign Data Bus to a target modular microservice; and write interaction-related data to a behavior chain, an identity chain, and an asset chain while applying a lifecycle policy to the interaction data.
